(19) United States
(12) Patent Application Publication
(10) Pub. No.: US 2017/0362870 A1
(43) Pub. Date: Dec. 21, 2017

(54) Automatic stay open upright toilet seat spring hinge structure

(71) Applicant: Jose Vera, Tampa, FL (US)

(72) Inventor: Jose Vera, Tampa, FL (US)

(21) Appl. No.: 15/184,072

(22) Filed: Jun. 16, 2016

(51) Int. Cl. E05F 1/12; E05D 5/04; A47K 13/12

(52) U.S. Cl. CPC E05F 1/12; A47K 13/12; E05D 5/04

(57) ABSTRACT

This present invention with the new added structure improvements to a single spring hinge for automatically keeping a toilet seat open and raised in an upright vertical position at all times.

the previous single spring hinge which a patent had already been granted by the U.S. PTO (Publication Number U.S. Pat. No. 4,751,765 A (Application Filed Number U.S. Ser. No. 06/938,604) which mainly utilizes the tension adjustment stand, made of metal or plastic composite material, to preserve the original intended functions,
the spring hinge which includes a first member, a second member, a spring, a spring seat, a tensile adjustment seat, a tensile adjustment pin, a shaft, and two holding heads.

The holding heads each include a hollow hat and a set of slots radially extending to form a set of claws fixed inside the hollow hat, the central portion of the slots being inwardly concave and an opening whose diameter is slightly smaller than the diameter of the shaft.

Thus, the shaft penetrating through the opening is pressed and secured by the claws so as to prevent any withdrawal of the shaft from the opening.

### BACKGROUND OF THE INVENTION

This present invention relates to a structure improvement to a door spring hinge and now particularly for use as an Automatic stay open upright toilet seat spring hinge with the new added improvements.

This kind of spring hinge utilizes the torque spring to store the tensile strength in order to accomplish the function of automatically keeping a toilet seat raised open in an upright position at all times

The spring hinge when mounted on any toilet bowl and toilet seat. Can make toilet seat automatically spring back up when push down in the opposite direction of the spring tension it will automatically spring back open in the upright position.

With the aforementioned improvement, the Automatic stay open upright toilet seat spring hinge will smoothly raise the toilet seat automatically these improved portions are enough to ensure the structural stability enhance durability, and increase actual functions

The tension adjustment stand can be made of metal or plastic

the previous single spring hinge which a patent had already been granted by the U.S. PTO (Publication Number U.S. Pat. No. 4,751,765 A (Application Filed Number U.S. Ser. No. 06/938,604) which mainly utilizes the tension adjustment stand, made of metal or plastic composite material, to preserve the original intended functions,
the spring hinge which includes a first member, a second member, a spring, a spring seat, a tensile adjustment seat, a tensile adjustment pin, a shaft, and two holding heads.

The holding heads each include a hollow hat and a set of slots radially extending to form a set of claws fixed inside the hollow hat, the central portion of the slots being inwardly concave and an opening whose diameter is slightly smaller than the diameter of the shaft.

Thus, the shaft penetrating through the opening is pressed and secured by the claws so as to prevent any withdrawal of the shaft from the opening.

### BRIEF SUMMARY OF THE INVENTION

The primary object of the present invention is to provide an Automatic stay upright open toilet seat spring hinge structure which is easier to manufacture and is safer because the connection between its holding heads and shaft is simplified and firmly secured together.

In accordance with the present invention, it can utilize reinforced plastic or metal the spring hinge includes a first member, a second member, a spring, a spring seat, a tensile adjustment seat, a tensile adjustment pin, a shaft and two holding heads, characterized in that the holding head underneath it includes a hollow hat, the central portion of the retaining member being inwardly concave and providing a set of radial slots extending to form a set of claws and an opening whose diameter is slightly smaller than the diameter of the shaft, and thus, the shaft penetrating through the opening is pressed and secured by the claws to prevent any withdrawal of the shaft.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The present invention will be more fully understood from the following detailed description, taken in connection with the accompanying drawings which form an integral part of this application and in which:

### BRIEF DESCRIPTION OF THE DRAWINGS

FIG. 1 is an exploded view of a spring hinge according to the art work;

FIG. 2 is an exploded view of a spring hinge according to the preferred embodiment of this invention;

FIG. 3, is a cross sectional view of the spring hinge shown in FIG. 2; and

FIG. 4, is a plane view of a holding head of the spring hinge shown in FIG. 2.

### DETAILED DESCRIPTION OF THE PREFERRED EMBODIMENTS

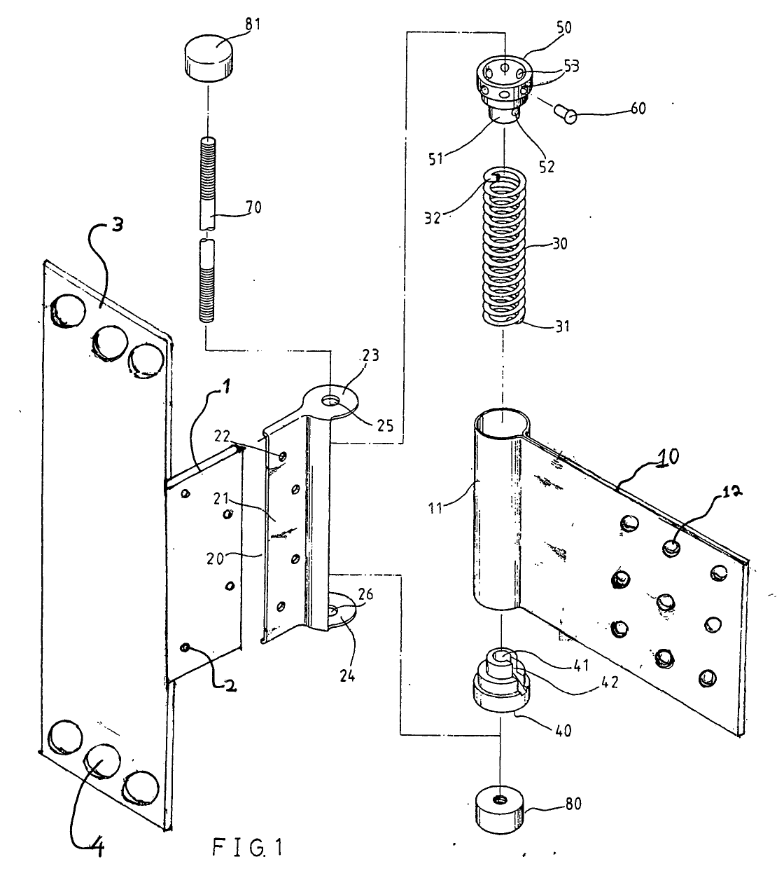

As shown in FIG. 1, to The previous invention by adding and extending first member flanges protruding plates (10) by 4 to 4½ inches long and is provided with 9 securing holes (12) for mounting the hinge on a toilet seat, The second member (20) which has 4 Securing holes (22) are provided on the plate which is then attached to a lip (1) the lip which has 4 Securing holes (2) and is attached on a rectangular plate (3) which has 6 Securing holes (4) 3 on each side for adjustment fitting for mounting on the toilet bowl.

As shown in FIG. 1, generally, the spring hinge includes a first member 10, a second member 20, a spring 30, a spring seat 40, a spring tensile adjustment seat 50, a tensile adjustment pin 60, shaft 70 and two holding heads 80, 81.

One side of the first member (10) is 4 to 4½ inches long As shown in FIG. 1, and is provided with 9 securing holes (12) is curved to form a tubular portion (11) while The second member (20) flat plate portion which has 4 Securing holes (22) is provided which is then attached to a rectangular plate with a lip (1) the lip which has 4 Securing holes (2) The spring seat 40 has a central hole 41 providing for the penetration of shaft 70. As shown in FIG. 1, on the edge of the hole 41 a gap 42 is provided for embedding one end 31 of spring 30 in position within the spring seat 40. Besides, this spring seat 40 is secured at the bottom of

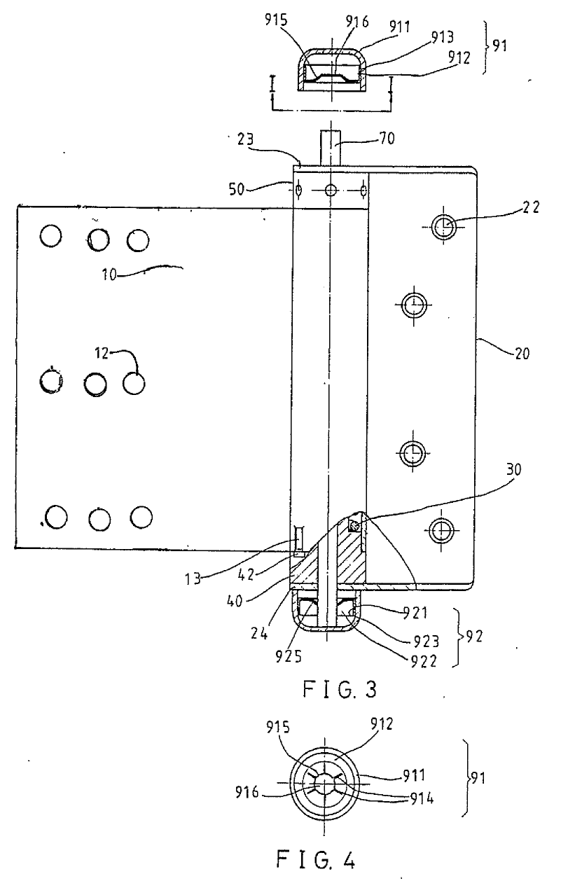

The tubular portion 11 of the first member by screwing or riveting As shown in FIG. 3 the gap 42 of spring seat 40 is embedded and blocked against a concave part 13 As shown in FIG. 3, provided at the bottom end of the tubular portion 11 As shown in FIG. 1, The bottom end 31 of spring 30 can be connected to the first member 10 by means of the spring seat 40 indirectly.

The bottom of the tensile adjustment seat 50 as shown in FIG. 1 can be inserted into the top end of the tubular portion 11 of the first member 10 and is provided with an aperture 52 for the insertion of the top end 32 of spring 30 therein. The second member 20 includes a plate portion 21 and two connecting pieces 23, 24 located at the top and bottom ends of one side respectively. Securing holes 22 are provided on the plate portion 21 for mounting the member 20 to a lip (1) the lip which has 4 Securing holes (2) is attached on a rectangular plate (3) which has 6 Securing holes (4) 3 on each side for adjustment fitting for mounting on the toilet bowl, and each connecting piece 23, 24 includes a hole 25, 26 formed therein, respectively.

The two connecting pieces 23 and 24 are pressed into the spring seat 40 and tensile adjustment seat 50 respectively and hold the first member 10 and second member 20 together to form a hinge by means of the penetration of the shaft 70 between them. Besides, a spring tension can be maintained between the first member 10 and second member 20 to adjust the tensions of the spring by inserting the tensile tension adjustment rod on one of the tension adjustment holes 53 pushed in one direction to get the right tension needed hold and maintain till the desired tension is achieved then insert tension adjustment dowel pin 60 into one of the suitable adjustment holes 53 located on the tensile adjustment seat 50 To hold at the desired tension.

It should be noted that the other side of the first member 10 can also be curved to form another tubular portion for connecting with a third member which is the same as the second member 20 in order to provide a double spring hinge.

The holding heads of known spring hinges, also called cap nuts such as shown in FIG. 1, are made of metal or plastic with or without internal thread which can be screwed on the external thread ends of the shaft 70 or if the holding heads cap nuts have internal push radial slots claw which can be push in at the ends of the shaft 70 Connecting and holding heads cap nuts 80, 81 and shaft 70 from falling off easily and frequently. Both providing and connecting the holding heads and penetrated shaft together.

### DETAILED DESCRIPTION OF THE INVENTION

Referring now to the drawings, there is shown the spring hinge according to one preferred embodiment of the present invention. It should be noted that the first member 10, second member 20, spring 30, spring seat 40, tensile adjustment seat 50 and tensile adjustment pin 60 are similar to that of the known spring hinge shown in FIG. 1.

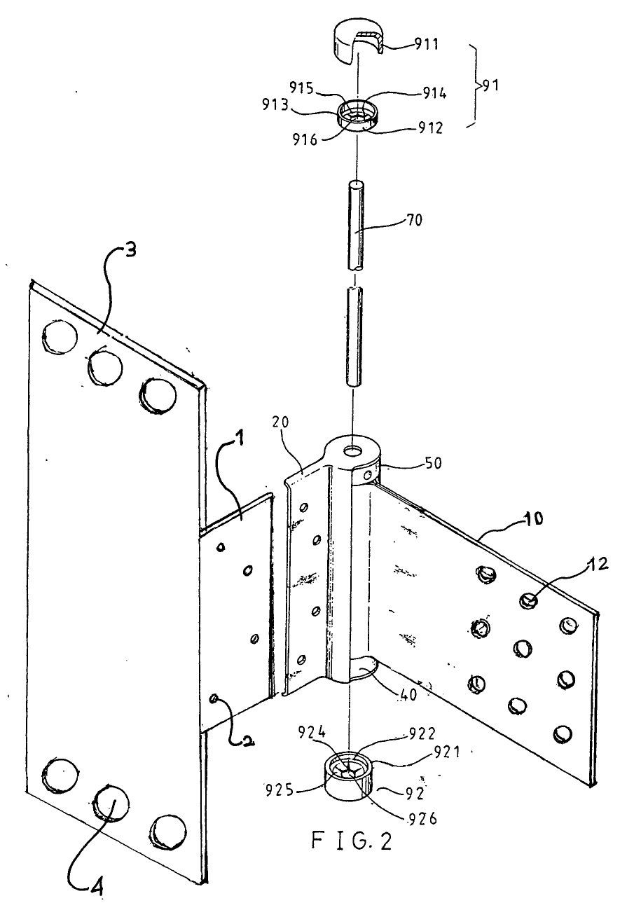

According to the present invention, as shown in FIG. 3, the shaft 70 is not threaded for engagement with the holding heads 91 and 92 including a hollow hat 911, 921 and a retaining member 912, 922. The edge of the retaining member is provided with veins, so that it can be firmly inserted and fixed inside the hollow hat. Firstly, the retaining member is put inside the hollow hat, and then the veins 913 and 923 as shown in FIG. 3, are pushed inwardly to fix it into position. Referring now to shaft retaining member 922, as shown in FIG. 2, its central portion includes a set of slots 924 radially extending to form a set of claws 925 extending inwardly and an opening 926 located at the tip portion of each claw. The diameter of the opening 926 is slightly smaller than the diameter of shaft 70, for the insertion of the shaft 70. As shown in FIG. 2, it should be noted that since the diameter of opening 926 is smaller than the diameter of shaft 70, the shaft when penetrating through the opening 926 will be pressed and secured by the claws to prevent any withdrawal of the shaft from the opening.

When the inserted shaft 70 reaches the hollow hat 921, as shown in FIG. 2, its flat end will press against the bottom of the hollow hat so that the shaft can be connected firmly and rigidly together with the entire holding head 92. Of course, the hollow hat and retaining member can be in the form of other shapes besides a circle, such as a hexagon or the like. It should be understood that, according to the present invention, the shaft and holding head do not require any external or internal threads. During assembly, a pushing operation is performed instead of rotating the holding head. Accordingly, the manufacturing speed can be increased approximately three times and is greatly simplified. Moreover, the hinge provides for a safer operation and prevents the dropping out of the holding head.

While the invention has been described in connection with what is presently considered to be the most practical and preferred embodiment, it is to be understood that the invention is not to be limited to the disclosed embodiment but on the contrary, is intended to cover various modifications and equivalent arrangement included within the spirit and scope of the appended claims which scope is to be accorded the broadest interpretation so as to encompass all such modifications and equivalent structures. Based on afore discussed improvement the spring hinge of the present invention ensures smoothly automatic closing and opening without causing any noise or deformation. Note that the specification relating to the above embodiment should be construed as exemplary rather than as limitative of the present invention, with many variations and modifications being readily attainable by a person of average skill in the art without departing from the spirit or scope thereof, as defined by the appended claims and their legal equivalents.

What is claimed is:

1. A spring hinge comprising of a newly added structure improvement to a single spring hinge for automatically keeping a toilet seat raised in an upright vertical position at all times;
The previous invention had short flanges and by adding the newly structure improvement by extending first member flanges protruding plates by 4½ inches long and is provided with 9 securing holes for mounting the hinge on a toilet seat,
A new structure comprising of a rectangular base plate with a lip which has 6 Securing holes 3 on each side for adjustment fitting for mounting on the toilet bowl the lip which has 4 Securing holes is attached to connecting piece the spring hinge assembly.
